(19) United States
(12) Patent Application Publication
(10) Pub. No.: US 2012/0260509 A1
(43) Pub. Date: Oct. 18, 2012

(54) HAND HELD DEVICE HAVING A ROTATIONAL AXIS

(76) Inventors: Dong Fang, Shanghai (CN); Florina Winter, Singapore (SG); Ashok Bakul Patel, Needham, MA (US); Rache Jane Otter, Reading (GB); Matthias Richard Hien, Reading (GB); Andrew Anthony Szczepanowski, North Attleboro, MA (US)

(21) Appl. No.: 13/444,886

(22) Filed: Apr. 12, 2012

Related U.S. Application Data
(60) Provisional application No. 61/476,075, filed on Apr. 15, 2011.

(51) Int. Cl. B26B 21/52; B25G 1/10

(52) U.S. Cl. 30/527; 16/421

(57) ABSTRACT

A hand held device comprising a handle, said handle comprising a grip portion and a connection portion, said connection portion rotating with respect to said grip portion about a rotational axis, said connection portion forming a docking portion suitable for receiving an optional head unit, said docking portion being positioned opposite distally away from said grip portion, wherein rotation of the connection portion relative to the grip portion generates a specific amount of dynamic torsional resistance. The handle has a set amount of stiffness and damping and/or stiffness and momentum of inertia such that the device provides a controlled return during rotation about the rotational axis so the device can contour about the surface in a desirable manner.

### CROSS REFERENCE TO RELATED APPLICATION(S)

This application claims priority to U.S. Provisional Application No. 61/476,075, filed Apr. 15, 2011, the subject of which is herein incorporated by reference in its entirety.

### BACKGROUND OF THE INVENTION

Some hand held devices such as safety razors have a head unit (such as a blade unit) connected to a handle for a pivotal movement about a single pivotal axis which is generally perpendicular to the major axis of the handle itself. The single pivotal axis can also be substantially parallel to the blade (i.e., the blade edge) when the device is a safety razor. For safety razors, the pivotal movement about the single axis provides some degree of conformance with the skin allowing the blade unit to easily follow the skin contours of a user during shaving. The pivot axis, which usually extends parallel to the cutting edges of the blades, can be defined by a pivot structure where the handle is connected to the blade unit. Such safety razors have been successfully marketed for many years. However, the blade unit often disengages from the skin during shaving as it has limited mobility due to pivoting about only a single axis.

To address this problem, it has been suggested that the safety razors be provided with blade units that can additionally pivot about another axis which is substantially perpendicular to the blade(s). Such safety razors do provide improved conformance of the blade unit to the contours of the face during shaving.

While these safety razors which provide a blade unit that pivots about two axes (e.g., pivotal and rotational movement) help the blade unit to more suitably follow the contours of the face during shaving, they do not follow all the contours of the body during shaving. Various attempts to provide safety razors with multiple axes include: U.S. Pat. Nos. 4,152,828; 5,070,614; 5,526,568; 5,535,518; 5,560,106; 6,115,924; 6,311,400; 6,381,857; 6,615,498; 6,973,730; 7,140,116; 5,526,568; and 5,033,152; and U.S. Patent Publ. Nos. 2008/034591; 2010/1013220; 2010/0313426; and 2011/0035950.

It has been found that by providing a safety razor having both pivotal and rotational movement the blade unit can closely follow all the contours of the body during shaving.

Thus, there is a need for a hand held device having a head unit capable of rotational movement about a rotational axis, wherein rotation of said head unit from an at-rest position creates a certain amount of dynamic torsional resistance, which may allow the hand held device to be suitable for use as a hair removal device.

### SUMMARY OF THE INVENTION

One aspect of this invention relates to a handle for use on a hand held device, said handle comprising: a grip portion and a connection portion, said connection portion rotating with respect to said grip portion about a rotational axis, said connection portion comprising a docking portion suitable for receiving an optional blade unit, said docking portion being positioned opposite distally away from said grip portion, wherein the grip portion and the connection portion are rotatably connected by a connection member, and wherein said handle comprises a static stiffness in a range of about 1.25 N*mm/degree to about 1.45 N*mm/deg, as determined by the Static Stiffness Method defined herein.

The foregoing aspects can include any one or more of the following features. Said blade unit can comprise at least one blade, said head unit pivots with respect to the connection portion about a pivot axis substantially parallel to said at least one blade. The handle can have a damping in a range of about 0.03 N*mm*sec/degrees to about 0.6 N*mm*sec/degrees, as determined by the Pendulum Test Method, defined herein. The handle can have a damping of from about 0.13 N*mm*seconds/degree to about 0.16 N*mm*sec/degree, as determined by the Pendulum Test Method defined herein, and a primary momentum of inertia of moving handle parts of from about 0.05 kg*mm̂2 to about 1 kg*mm̂2. A primary momentum of inertia of all moving parts can be in a range of 0.5 kg*mm̂2 to 3 kg*mm̂2, preferably about 1 kg*mm̂2 to about 2 kg*mm̂2, most preferably about 1.2 kg*mm̂2. A shortest distance from rotational axis to the pivot axis of the head unit can be in a range of about 0 mm to about 10 mm The connection member can be permanently attached to at least one of said grip portion and said connection portion. The connection member can be removably attached to at least one of said grip portion and said connection portion. A material forming at least a portion of the connection member and/or the connection portion can comprise at least one of a polymeric material, steel, or a combination thereof, and wherein said polymeric material is selected from the group consisting of: an acetal, a polyacetal, a polyoxymethylene, polyphenylene sulfide, a polyamide, a polybutylene terephthalate, a thermoplastic elastomer, a thermoset elastomer, a polyurethane, a silicone, a nitrile rubber, a styrenic block copolymer, polybutadiene, polyisoprene, and mixtures or copolymers thereof. Rotating said connection portion from a zero position by 12° can generate about 21 Nmm to about 24 Nmm of torque. The connection portion and the connection member can be integrally formed.

Another aspect of this invention relates to a handle for a safety razor comprising: a grip portion and a connection portion, said connection portion rotating with respect to said grip portion about a rotational axis, said connection portion comprising a docking portion suitable for receiving an optional blade unit, said docking portion being positioned opposite distally away from said grip portion, wherein the grip portion and the connection portion are connected by a rod, said rod comprising a distal end non-rotatably attached to the grip portion and a proximal end non-rotatably attached to the connection portion, wherein said rotational axis forms a central longitudinal axis of said rod, wherein said handle comprises: a static stiffness in a range of about 0.3 N*mm/degree to about 2.5 N*mm/deg, as determined by the Static Stiffness Method defined herein, and a damping in a range of about 0.03 N*mm*sec/degrees to about 0.6 N*mm*sec/degrees, as determined by the Pendulum Test Method, defined herein.

This aspect can include any one or more of the following features. Said blade unit can comprise at least one blade, said head unit pivots with respect to the connection member about a pivot axis substantially parallel to said at least one blade. The handle can have a primary momentum of inertia of moving handle parts in a range of about 0.05 kg*mm̂2 to about 1 kg*mm\hat{2}. The handle can have a damping of from about 0.13 N*mm*seconds/degree to about 0.16 N*mm*sec/degree, as determined by the Pendulum Test Method defined herein, and a primary momentum of inertia of moving handle parts of from about 0.05 kg*mm̂2 to about 1 kg*mm\hat{2}. A primary momentum of inertia of all moving parts can be in a range of 0.5 kg*mm̂2 to 3 kg*mm̂2, preferably about 1 kg*mm̂2 to about 2 kg*mm̂2, most preferably about 1.2 kg*mm̂2. A shortest distance from rotational axis to the pivot axis of the head unit can be in a range of about 0 mm to about 10 mm. The rod can be permanently attached to at least one of said grip portion and said connection portion. The rod can be removably attached to at least one of said grip portion and said connection portion. A material forming at least a portion of the rod can comprise at least one of a polymeric material, steel, or a combination thereof, and wherein said polymeric material is selected from the group consisting of: an acetal, a polyacetal, a polyoxymethylene, polyphenylene sulfide, a polyamide, a polybutylene terephthalate, a thermoplastic elastomer, a thermoset elastomer, a polyurethane, a silicone, a nitrile rubber, a styrenic block copolymer, polybutadiene, polyisoprene, and mixtures or copolymers thereof. Rotating said connection portion from a zero position by 12° can generate about 21 Nmm to about 24 Nmm of torque. The connection portion and the rod can be integrally formed.

### BRIEF DESCRIPTION OF THE DRAWINGS

FIG. 1 is a side view of a hand held device in accordance with at least one embodiment of the present invention.

FIG. 2 is a side view of another hand held device in accordance with at least one embodiment of the present invention.

FIG. 3 is a side view of the hand held device of FIG. 2, with the blade unit partially rotated. The relative movement of the surface indicia in these exemplary figures is provided to more clearly show the rotational movement.

FIG. 4 is a bottom view of a hand held device in accordance with at least one embodiment of the present invention. In this example, the device is a safety razor.

FIG. 5 is a top view of the device shown in FIG. 4.

FIG. 6 is a top view of another hand held device in accordance with at least one embodiment of the present invention.

FIG. 7 is a frontal view of a hand held device in accordance with at least one embodiment of the present invention.

FIG. 8 is a frontal view of the device of FIG. 7 where the blade unit is pivoted back.

FIG. 9 is another frontal view of the device of FIG. 7, with the blade unit rotated counterclockwise.

FIG. 10 is another frontal view of the device of FIG. 7, with the blade unit rotated clockwise.

FIG. 11 is another frontal view of the device of FIG. 7, with the blade unit pivoted back and rotated counterclockwise.

FIG. 12 is another frontal view of the device of FIG. 7, with the blade unit pivoted back and rotated clockwise.

FIG. 13A-13C are side views of connection members in accordance with at least one embodiment of the present invention.

FIG. 14 is a side view of yet another connection member in accordance with at least one embodiment of the present invention.

FIGS. 15A-15B are side views of a connection member at rest and having one end rotated.

FIGS. 16A-16B are side views of a connection member at rest and having one end rotated.

FIG. 17 is perspective view of another connection member in accordance with at least one embodiment of the present invention.

FIG. 18A is a top view of a finger pad in accordance with at least one embodiment of the present invention.

FIG. 18B is a cross section view of the finger pad of FIG. 18A taken along view line A-A.

FIG. 19 is another top view of a finger pad according to an embodiment of the present invention.

FIG. 20A is a top view of another finger pad in accordance with at least one embodiment of the present invention.

FIG. 20B is a cross section view of the finger pad of FIG. 20A taken along view line B-B.

FIG. 21 is a side view of a simplified diagram of a hand held device according to an embodiment of the invention.

FIGS. 22A and 22B are schematic perspective and exploded views of a portion of a setup for conducting the Static Stiffness Method.

FIGS. 23A and 23B are schematic perspective views of a setup for conducting the Pendulum Test Method.

FIG. 24 is a side view of a simplified diagram for a setup for conducting the Pendulum Test Method.

FIG. 25 is a graph of data used to calculate a damping coefficient of a connection portion according to an embodiment of the present invention.

FIG. 26 is a graph of data used to calculate a damping coefficient of a connection portion in accordance with an embodiment of the present invention.

### DETAILED DESCRIPTION OF THE INVENTION

The present invention addresses the need for a hand held device having a head unit capable of a pivotal movement about a pivot axis and rotational movement about a rotational axis which is suitable for use as a hair removal device by providing a handle comprising a grip portion and a connection portion, said connection portion rotating with respect to said grip portion about a rotational axis, wherein the grip portion and the connection portion are connected by a connection member. In an embodiment, the connection member can be a torsional retention member, for example, such as a rod. The rod comprises a distal end non-rotatably attached to the grip portion and a proximal end non-rotatably attached to the connection portion, wherein rotational axis forms a central longitudinal axis of said rod, and wherein said connection portion forming a docking portion suitable for receiving an optional head unit, such as a blade unit, said docking portion being positioned opposite distally away from said rod and/or said grip portion. In another embodiment, the torsional retention member comprises a bore formed in the grip portion of the handle and a rod formed in or attached to the connection portion of the handle, wherein the bore of the grip portion receives the rod of the connection portion, as generally described in U.S. Patent Publ. Nos. 2010/0313426 and 2011/0035950. In one embodiment, the rod may comprise a pin extending radially outward therefrom.

It is believed that a certain range or amount of resistance can be desirable when the device is used on various parts of the human body. Because the connection portion rotates about the rotational axis thereby generating a return force biasing the device to an at rest position, as the device rotates, there is a certain amount of dynamic resistance that can allow for improved contact between the blade unit (e.g., a cartridge) and the surface being contacted, while avoiding any excessive force that could be uncomfortable.

In one embodiment, the dynamic resistance, or dynamic torque, results in a desired and useful dynamic motion of components that rotate relative to components that are fixed in response to any contours or non linear movements of the device across the surface being treated. This dynamic resistance dictates the dynamic behavior of the components that rotate such as the speed and amount of the deflection of the components that rotate from its initial position in response to changes in surface contour or handle position. In a preferred embodiment, components that are fixed may include the grip portion and the components that rotate relative to the components that are fixed may include the connection member, connection portion, and/or the head unit, which may, optionally, move relative to the connection portion about a pivot axis. In an alternative embodiment, components that are fixed may include the grip portion and the connection member and the components that rotate relative to the components that are fixed may include the connection portion and/or the head unit, which may, optionally, move relative to the connection portion about a pivot axis. In yet another embodiment, the connection member and/or the connection portion may have a portion or an end thereof that rotates relative to another portion or another end.

Without intending to be bound by theory, it is believed that this dynamic response can be impacted by multiple factors, including but not limited to the stiffness of the connection member, the damping/frictional effects on the connection member, the distribution of mass about the rotational axis in the components that rotate (momentum of inertia), and the shortest distance from the rotational axis to the center of mass of the components that rotate. It is believed that this dynamic response may be described by differential equations that are slightly non-linear and which have coefficients of the differential equations that depend on relative angular position and rotational speed of the components that rotate relative to its at rest position and on environmental conditions such as shaving speed, axle load, or temperature.

Although the actual differential equations are non-linear and have varying coefficients, various aspects of the dynamic response related to shaving can be understood using a simplified model showed in Equation A that has linear differential equations with constant coefficients for stiffness, damping, and momentum of inertia.

$$\frac{d}{d t} ( \begin{matrix}\frac{d {θ}_{p}}{d t} \\ {θ}_{p}\end{matrix} ) = [ \begin{matrix}\frac{- C}{I} & \frac{- K}{I} \\ 1 & 0\end{matrix} ] ( \begin{matrix}\frac{d {θ}_{p}}{d t} \\ {θ}_{p}\end{matrix} ) + [ \begin{matrix}\frac{K}{I} & \frac{C}{I} & \frac{1}{I} & \frac{L}{I} \\ 0 & 0 & 0 & 0\end{matrix} ] ( \begin{matrix}{θ}_{h} \\ \frac{d {θ}_{h}}{d t} \\ {T}_{c} \\ {F}_{c}\end{matrix} ) \qquad ( Equation A )$$

where
θp=connection portion rotation;
θh=grip portion rotation;
I=Total momentum of inertia of components that rotate;
C=damping coefficient;
K=stiffness;
T_{c}=Resultant torqe on head unit from shaved surface;
F_{c}=Resultant force on head unit from shaved surface; and
L=shortest distance from the axis of rotation of the connection portion to the pivot axis of the blade unit or, for fixed pivot blade units, the center of mass of the blade unit.

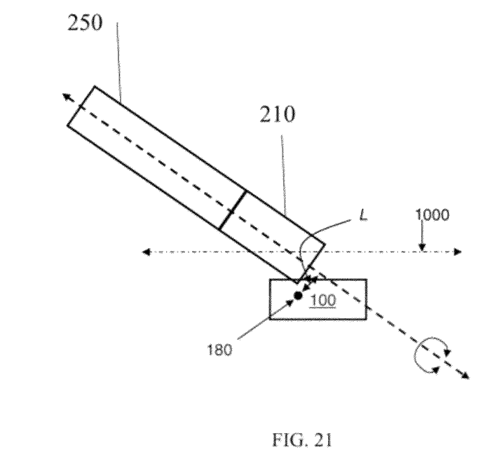

For purposes of illustration, L is shown in FIG. 21. FIG. 21 is a side view of a simplified hand held device having a grip portion (250) connected to a connection portion (210), which rotates relative to the grip portion (250). A head unit or cartridge (100) is connected to docking portion of the connection portion (210). Further a horizontal line (1000) is shown. Pivot axis (180) is shown extending normal out of the viewing plane.

Those of skill in the art will understand that the formula for Equation A is derived from basic fundamentals of system dynamics. See, e.g., Kasuhiko Ogata, System Dynamics (4^{th} ed, Pearson 2003); Jer-Nan Juang, Applied System Identification (Prentice Hall, 1994); Rolf Isermann and Marco Munchhof, Identification of Dynamic Systems: An Introduction with Applications (1^{st} ed. 2011). Equation A can be used to calculate the desired torque response of a pod. The ranges of the values in Equation A are those that can be determined using standard methods of system dynamics and/or system identification. Simplified equations to determine certain values are described in the Test Methods section. Further, commercial software packages to carry out these techniques are available from The Mathworks, Inc. and National Instruments.

Without intending to be bound by theory, it is believed that the values of each of the parameters—stiffness, damping, momentum of inertia, and distance between the axis of rotation and axis of pivoting of the cartridge—are important to the torque response of the handle. This response allows the razor cartridge to contour the skin surface in a desirable manner. Without intending to be bound by theory, it is believed that various portions and contours of skin can be shaved using this type of device, including but not limited to the face, the neck, the jaw, underarms, torso, back, pubic area, legs and so forth.

It is believed that stiffness provides the restoring torques to counter deviations from the initial “at rest” position of the components that rotate, where if a cartridge were attached to the docking portion it would be considered centered. Stiffness relates to the proportionality constant between the torque required to hold the components that rotate at a constant angular deflection position from its initial position. During actual shaving motions, high values of stiffness make it more difficult for the components that rotate to undertake large deviations from an at rest position while low values of stiffness make it easier for the components that rotate to be deflected from its initial position.

It is further believed that the damping is the proportionality constant that relates the component of the torque resisting motion to speed. Damping is especially important because its presence at certain levels prevents the components that rotate from feeling too loose to the user at small angle deviations from the initial position of the components that rotate. At these small angle deviations, the resisting torques from damping constitute significant portion of the dynamic response because the torque from the stiffness components are small.

It is further believed that momentum of inertia is the proportionality constant that relates the component of the torque resisting motion that is due to acceleration. Higher values of momentum of inertia make the dynamic response of the handle more sluggish.

The distance from the axis of rotation to the axis of pivoting of the blade unit (e.g., a cartridge) or, for fixed pivot blade units, the center of mass of the blade unit is also an important parameter. For a given set of parameters—stiffness, damping, and momentum of inertia—this length has been shown to be important to the feel of the razor during shaving as it is related to the forces and torques transmitted to the face from the razor.

Determining the values of a handle's parameters while shaving using Equation A can be challenging. For stiffness and damping, two simple methods are outlined below which allow a person skilled in the art of system dynamics and system identification to determine their values. The first method is the Static Stiffness Method, and it can be used to determine the value of stiffness for the handle. The second method is the Pendulum Test Method, and it can be used to determine the values of the damping coefficient for a given test condition. Determination of momentum of inertia about an axis of rotation is a simple calculation by equations found in introductory textbooks in solid mechanics. Many computer aided design packages (CAD) such as Solidworks or ProEngineer automatically calculate the momentum of inertia of a component around a given axis. The distance from the pivot axis of the blade unit to the axis of rotation of the connection portion can be determined by direct measurement.

In one embodiment the torsional retention member has a static stiffness of from about 0.3 N*mm/degree to about 2.5 N*mm/degree, or from about 0.5 N*mm/degree to about 1.5 N*mm/degree, preferably about 0.95 N*mm/degree to about 1.35 N*mm/degree, as determined by the Static Stiffness Test Method, below. Those of skill in the art will understand that the stiffness of the torsional retention member is impacted by both the composition used to form the torsional retention member as well as the structural design of the torsional retention member (including aspects such as thickness, length, and so forth). As such, depending on the specific type of torsional retention member being used (in this case the rod), using the same material can result in a different stiffness result depending on the design. Conversely, using a different material can still result in a stiffness within the present range, depending on the design.

### Test Methods

(1) Static Stiffness Method:

Without intending to be bound by any theory, it is believed that the static stiffness of a handle described herein can be determined using a static stiffness method in which torques are measured relative to angles of displacement of the components that rotate from its rest position. Static stiffness is understood to be the measurement of proportionality constant between torque and the angle when the relative angle between the components that rotate and the components that are fixed is held constant.

(a) Definitions and Environment Conditions for Static Stiffness:

The various parts of a hand held device, such as a safety razor, that help to understand the static stiffness value include components that are fixed and components that rotate relative to the components that are fixed.

The angles of displacement measured in accordance with the Static Stiffness Method are the angles of deflection of the components that rotate relative to the at rest position of said components. The angle is defined as the relative angle of the connection portion from the at rest position of the connection portion. The zero angle position of the connection portion is defined to be the rest position of the connection portion relative to the handle when (1) the handle is fixed in space, (2) the connection portion is free to rotate about its axis of rotation relative to the fixed handle, (3) the axis of rotation of the connection portion is oriented horizontally (parallel to the ground and perpendicular to the gravity vector), and (4) no external forces or torques other than those transmitted from the grip portion and gravity act on the connection portion. Prior to measurement, all rotations of the connection portion to one side of the zero angle position are designated as positive, while the rotations of the connection portion to the other side of the zero angle position are designated as negative.

The torque transmitted from the connection portion during relative motions of the connection portion is measured at a point coincident to the axis of rotation between the grip portion and the connection portion. The component of torque that is being measured is about the axis of rotation between the grip portion and the connection portion. For example, if the axis of rotation is coincident to the z-axis of a coordinate system, the torque that is being measured is in the z direction. The sign convention of the torque measurement is positive for positive rotations of the connection portion and negative for negative rotations of the connection portion.

The environmental test conditions for calculating static stiffness are as follows. Measurements are performed at room temperature, i.e., 23 degrees Celsius. Measurements of the hand held device are made in a dry, “as-made” condition.

(b) Measurement of the Torque-Angle Data

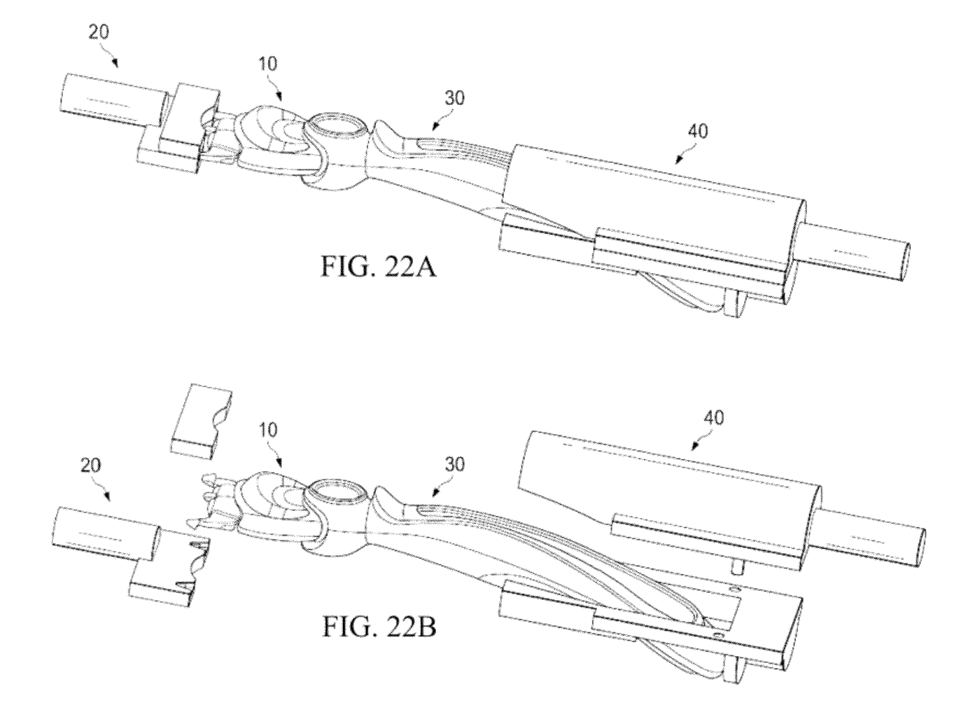

As partially depicted in FIGS. 22A and 22B, during measurements of the safety razor, the connection portion 10 of the safety razor is fixed in space by a first clamping mechanism 20 that does not affect the rotation of the grip portion 30 relative to the connection portion. In an embodiment, the first clamping mechanism clamps to a cartridge connection yoke/docking station portion of the connection portion. The grip portion is also secured to a second clamping mechanism 40. This configuration, with two clamping mechanisms is then placed into an Instron MT1 MicroTorsion tester for measurements, with an accuracy of +/−0.5% (for the torsional load cell) and repeatability of +/−0.5%. The axis of rotation of the connection portion 10 relative to the grip portion 30 is axially aligned (concentric) between the torsion tester and the grip portion 30 to isolate the connection member and minimize lateral loading. During measurements, the hand held device is oriented as follows: (1) the hand held device is placed in the torsion tester fixture; (2) the connection portion is clamped so as to be fixed in space, (3) the grip portion is clamped but is free to rotate about the axis of rotation between the grip portion and the clamped connection portion, and (4) the axis of rotation between the grip portion and the connection portion is oriented 0 degrees from horizontal (parallel to the ground and perpendicular to the gravity vector).

The following is the sequence for measurement of the torque-angle data of a safety razor. Clamp the hand held device into the testing fixture in the zero angle position. Make the 1^{st} measurement at the first positive value of the angle position being measured by moving the grip portion from the zero angle position to this first positive angle position. Wait 20 seconds to 1 minute at this angle position. Record the torque value. Move the grip portion back to the zero angle position and wait 1 minute. Move to the next angle position at which a measurement is being made. Repeat the foregoing steps until all measurements are made.

The following angles are angles at which torque measurements are made for a safety razor having a connection portion with a range of motion greater than or equal to about +/−5 degrees from the zero angle position. Torque will be measured for 15 angle measurements. The sequence of angle measurements in degrees is 1.0, 2.0, 3.0, 4.0, 5.0, 6.0, 7.0, 8.0, 9.0, 10.0, 11.0, 12.0, 13.0, 14.0, and 15.0.

The following angles are angles at which torque measurements are made for a safety razor having a connection portion with a range of motion less than about +/−5 degrees from the zero angle position. Torque will be measured for 10 different angle measurements at equally spaced increments. The increments will be equal to range of motion divided by 10. For example, if a connection portion of safety razor only has a range of motion from about −3 degrees to about +2 degrees, the increment is (2−(−3))/10=0.5 degrees; and the sequence of angle measurements in degrees is 0.0, 0.5, 1.0, 1.5, 2.0, 2.5, 3.0, 3.5, 4.0, and 4.5.

To determine the static stiffness value, plot the torque measurements (y-axis) versus the corresponding angle measurements (x-axis). Create the best fit straight line through the data using a least squares linear regression. The stiffness value is the slope of the line y=m*x+b, in which y=torque (in N*mm); x=angle (in degrees); m=stiffness value (in N*mm/degree); and b=torque (in N*mm) at zero angle from the best fit straight line.

(2) Pendulum Test Method:

Because damping is the result of phenomena such as friction, it can only be measured when the connection portion is in motion relative to its at rest portion. One test to determine the damping coefficient from the observed motion uses a rigid pendulum that is attached to connection portion in the same manner that a razor cartridge would be attached. The pendulum is designed to measure the damping coefficient under conditions that are relevant to shaving.

(a) Definitions and Environment Conditions for Pendulum Damping Coefficient Test Method:

The various parts of a hand held device, such as a safety razor, that help to understand the damping coefficient include components that can be fixed and components that rotate relative to the fixed components.

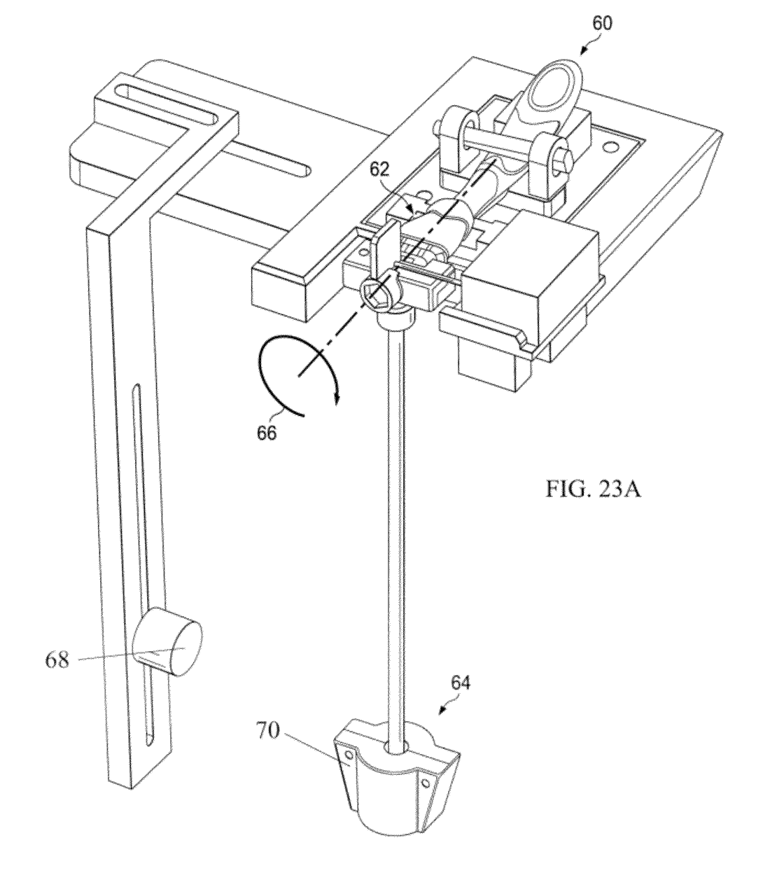

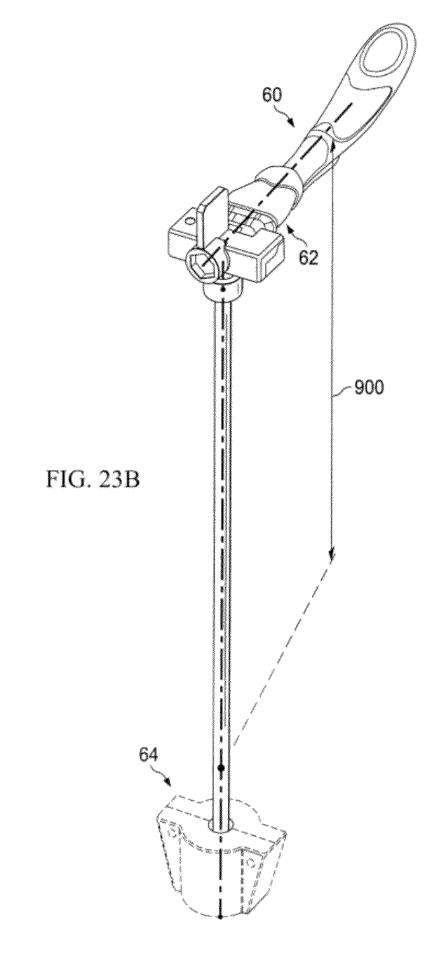

As depicted in FIGS. 23A and 23B, grip portion 60 is fixed to a platform and connection portion 62 is attached to a pendulum 64, which includes an elongated portion with an enlarged portion at one end. The connection portion 62 can rotate relative to the grip portion 60 about an axis of rotation 66. The grip portion 60 is fixed in space by a clamping mechanism that does not affect the rotation of the connection portion 62 and the pendulum 60 relative to the grip portion 60. When the pendulum 64 is at rest, the axis from the center of mass of the rotating components intersecting the axis of rotation 66 is parallel to the gravity vector. A cylinder 68 is attached to the platform in which the cylinder is magnetized. Sheet metal 70 is attached to the pendulum 60 in which the sheet metal is magnetized.

For the pendulum damping coefficient test method, the angle is defined as the relative angle of the connection portion from its at rest position. The angle is not the deviation of the pendulum from vertical. The zero angle position of the connection portion relative to the grip portion is defined to be the rest position of the connection portion relative to the grip portion when (1) the grip portion is clamped such that its orientation in space is fixed, (2) the connection portion (with attached pendulum) is free to rotate through its full range of motion about the axis of rotation between the fixed grip portion and the connection portion, (3) the axis of rotation between the connection portion and the grip portion is parallel to horizontal, and (4) no forces or torques other than those transmitted from the grip portion and from gravity act on the connection portion or the pendulum. Prior to measurement, all rotations of the connecting portion to one side of the zero angle position are designated as positive while the rotations of the connecting section to the other side of the zero angle position are designated as negative.

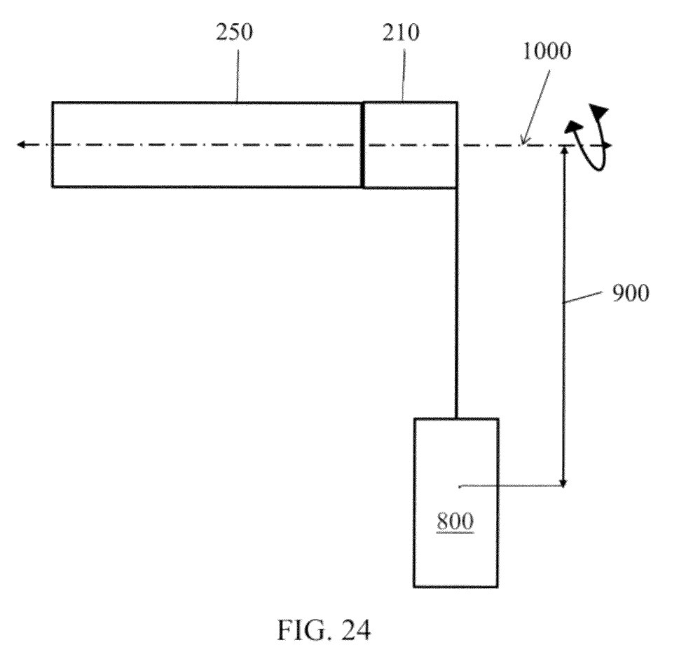

Depicted in FIG. 24 is a simplified side view of a setup for the Pendulum Test Method. A handle of a safety razor includes a grip portion 250 and a connection portion 210 connected to the grip portion 250 such that the connection portion 210 rotates relative to the grip portion 250. The axis of rotation of the grip portion is parallel to horizontal 1000. Pendulum 800, which includes an elongated portion and an enlarged portion at one end, is connected to the connection portion and Lp 900 is the shortest distance between the axis of rotation of the connection portion 210 and the center of mass of the pendulum 800.

The environmental test conditions for calculating the damping coefficient are as follows. Measurements are performed at room temperature, i.e., at 23 degrees Celsius. The hand held device, such as a safety razor, is submerged in de-ionized water also at room temperature, i.e., at 23 degrees Celsius, for 5 minutes, so that the safety razor is lubricated (i.e., wet). Measurements are made and completed while the safety razor is still wet within five minutes of removing the shaving razor from the de-ionized water.

(b) Measurement of Angle During the Pendulum Test

During measurements of the angle, the grip portion of the safety razor is fixed in space by a clamping mechanism that does not affect the rotation of the connection portion and the pendulum relative to the grip portion in any manner. During measurements, the razor is oriented as follows: (1) the grip portion is fixed in space by a clamp, (2) the connection portion which is connected rigidly to the pendulum is free to rotate about the axis of rotation between the connection portion and the grip portion, and (3) the axis of rotation between the grip portion and the connection portion is oriented about 0 degrees from horizontal.

The following is the sequence for measurement of the torque-angle data of a handle of a safety razor (i.e., excluding the head unit). Remove the safety razor from the de-ionized water. Clamp the safety razor into the testing fixture in the zero angle position. The safety razor is clamped in such a way so that compliance of the non-rotating components does not affect measurement of the relative angle. Rotate the connection portion and the pendulum to the specified release point, discussed further below. Begin recording the angle data versus time at a sampling rate of at least 50 Hz. Release the pendulum and record the angle data until the pendulum motion has stopped. The release of the connection portion/pendulum assembly must be accomplished from a stationary start—without imparting a rotational velocity to the assembly. This is accomplished by initially having the magnetized cylinder retain the pendulum via the magnetized sheet metal and having the pendulum be released. While the pendulum is retained by the magnetized cylinder, the pendulum is 12 degrees from vertical, i.e., its at rest position. This release must also not rub against the connection portion/pendulum assembly in any manner other than the forces and torques transmitted from the handle to the connection portion. The zero velocity/no rubbing pendulum release is to prevent the pendulum from being released while it is in motion or from affecting the acceleration of the pendulum after release. The sequence of measurements is to be completed within 1 minute.

The release point of the connection portion/pendulum assembly is the smaller of the maximum deviation of the connection portion to either side of the zero angle position. For example, if the range of motion of a connection portion of a safety razor is from about −5 degrees to about +4 degrees from the zero angle position, the release point would be +4 degrees. In another example, if the range of motion of connection portion of a safety razor is from about −9 degrees to about +12 degrees from the zero angle position, the release point is about −9 degrees.

(c) Calculation of the Damping Coefficient for a Connection Portion of a Safety Razor Having a Range of Motion Greater than or Equal to about +/−5 Degrees from the Zero Angle Position

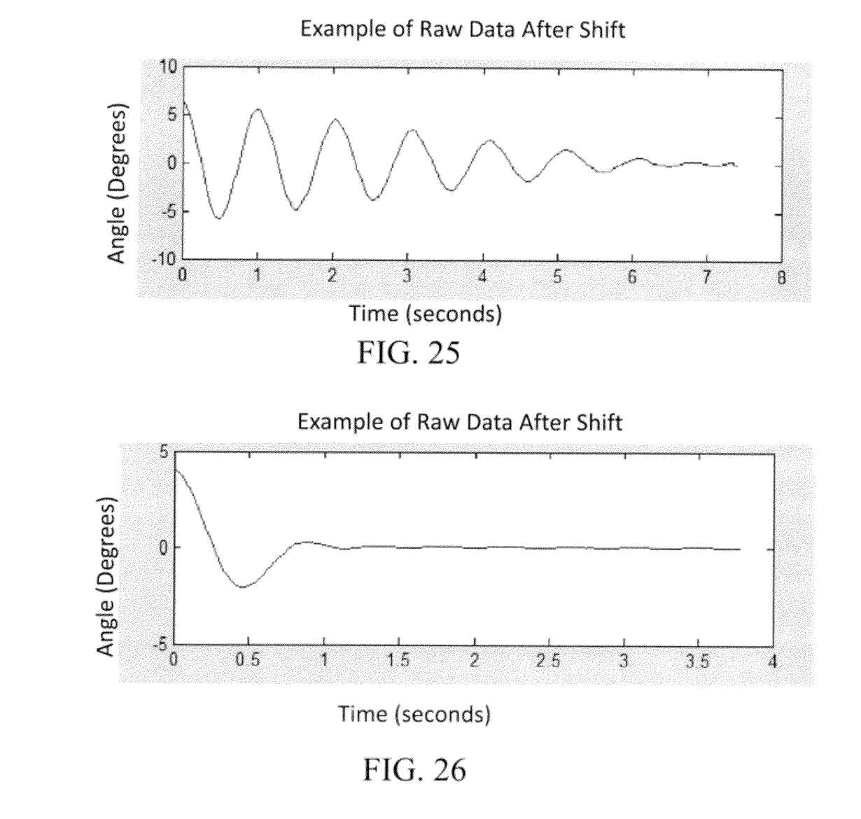

With reference to FIGS. 25 and 26 as examples, to calculate the damping coefficient, the connection portion is released at an absolute value of 12 degrees and the time sequence of data is truncated to eliminate the first wave as the first swing may not be a free swing.

The following equations can be understood to calculate the damping coefficient.

$$\begin{matrix}\frac{d}{d t} ( \begin{matrix}\frac{d θ}{d t} \\ θ\end{matrix} ) = [ \begin{matrix}\frac{- C}{{ML}_{p}^{2}} & - ( \frac{{K}_{d}}{{ML}_{p}^{2}} + \frac{g cos α}{{L}_{p}} ) \\ 1 & 0\end{matrix} ] ( \begin{matrix}\frac{d θ}{d t} \\ θ\end{matrix} ) & Equation B \\ \ddot{θ} + \frac{C}{{ML}_{p}^{2}} \dot{θ} + \frac{( {K}_{d} + {MgL}_{p} cos α )}{{ML}_{p}^{2}} θ = 0 & Equation C \\ ξ = \frac{C}{2 {ML}_{p}^{2} {ω}_{0}} and {ω}_{0} = \sqrt{\frac{{K}_{d}}{{ML}_{p}^{2}} + \frac{g cos α}{{L}_{p}}} & Equation D \\ ξ = \frac{C}{2 {ML}_{p}^{2} ( {K}_{d} + {MgL}_{p} cos α )} & \text{Equation E} \\ {ω}_{d} = {ω}_{0} \sqrt{1 - {ξ}^{2}} & \text{Equation F} \\ θ ( t ) = {e}^{- ξ {ω}_{0} t} ( A cos ( {ω}_{d} t ) + B sin ( {ω}_{d} t ) ) & \text{Equation G} \\ θ ( t ) = A {e}^{- {γ}_{1} t} + B {e}^{- {γ}_{2} t} & \text{Equation H} \\ θ ( t ) = ( A + B t ) {e}^{- {ω}_{0} t} & \text{Equation I} \\ C = {ML}_{p}^{2} ( {γ}_{1} + {γ}_{2} ) and {K}_{d} = {ML}_{p}^{2} {γ}_{1} {γ}_{2} - {ML}_{p} g cos α & \text{Equation J}\end{matrix}$$

where
θ=angle of rotation of the connection portion from the at rest position
α=smallest angle between the axis of rotation and the horizontal plane, which is perpendicular to the gravity vector
C=damping coefficient
K_{d}=dynamic stiffness
M=pendulum mass
Lₚ=the shortest distance between the center of mass of the pendulum and the rotational axis of the connection portion
g=gravitational constant
ω₀=undamped natural frequency of the grip portion-pendulum-connection portion assembly
ω_{d}=damped natural frequency of the grip portion-pendulum-connection portion assembly
A=coefficient based on angle initial condition at time=0
B=coefficient based on angle initial condition at time=0
ζ=Damping ratio.

Using a least squares curves fit, the values of the damping coefficient and the dynamic stiffness are determined using the solutions for the classic 2^{nd} order mass-spring-damper differential equation. Equations B and C are different forms of the same differential equation, which has Equations G, H, and I as possible solutions.

For data that exhibits oscillatory angle versus time behavior, Equation G can be used as the form of the solution to the differential equation to curve fit the angle versus time data. In Equation G, coefficients A and B depend on the initial conditions at time (t) after the data has been truncated.

For data that does not exhibit oscillatory angle versus time behavior, two possible forms for the solution to the differential equation exist (Equations H and I). Using a least squares fit, determine which form of the differential equation solution best fits the data based on R² by optimizing A, B, ω₀, γ₁ and γ₂ values. In Equations H and I, coefficients A and B depend on the initial conditions at time (t) after the data has been truncated. If Equation H is the best form of the solution to the differential equation, Equation J provides the dynamic stiffness (K_{d}) and the damping coefficient (C) using the solution to the characteristic equation of the 2^{nd} order differential equation given in Equation C. If Equation I is the best form of the solution to the differential equation, the dynamic stiffness (K_{d}) and the damping coefficient, C, can be solved from Equations D and E, where

$$ξ = \frac{C}{2 \sqrt{{ML}_{p}^{2} ( {MK}_{d} + {MgL}_{p} cos α}} = 1.$$

(d) Calculation of the Damping Coefficient for Safety Razors with a Connection Portion Having a Range of Motion Less than about +/−5 Degrees from the Zero Angle Position

Without truncating the data, the damping coefficient for the safety razors can be calculated using the steps outlined with respect to Equation B through Equation J.

The dynamic stiffness of the pendulum test is different from the static stiffness of the earlier test method because the dynamic stiffness is measured while the grip portion is moving relative to the connection portion. This motion may result in a different value of stiffness than the static stiffness test method because the elastic moduli of many spring materials (such as thermoplastics or elastomers) increase in value as the strain rate on the material increases. Springs made of these materials feel stiffer for the same amount of displacement when the springs are moved fast rather than slow. Generally, the dynamic stiffness of a hand held device having a connection portion is larger than that of its static stiffness, preferably about 20% larger, especially in light of a system having plastic components that flex since most plastic have elastic module that increase with strain rate.

In one embodiment, the damping coefficient is from about 0.02 N*mm*sec/degrees to about 0.6 N*mm*sec/degrees, as determined by the Pendulum Test Method, defined herein. Alternatively, the damping coefficient is from about 0.08 N*mm*sec/degrees to about 0.15 N*mm*sec/degrees, preferably about 0.1 N*mm*sec/degrees to about 0.2 N*mm*sec/degrees, and even more preferable from about 0.12 N*mm*sec/degrees to about 0.153 N*mm*sec/degrees. In another embodiment, the damping can be comparatively lowered to 0.003 N*mm*sec/degree to about 0.03 N*mm*sec/degree. In another embodiment, the damping is about 0.03 N*mm*sec/degree to about 0.5 N*mm*sec/degree. In another embodiment, the damping of the device is from about 0.2 N*mm*sec/deg to about 0.5 N*mm*sec/deg.

Alternatively, the Pendulum Test Method is conducted without dipping the safety razor into water; rather, the Pendulum Test Method is conducted while the safety razor is dry (“Dry Pendulum Test Method”). For example, the Dry Pendulum Test Method is conducted at room temperature, 23 degrees Celsius. For the Dry Pendulum Test Method, the damping can be in a range of about 0.02 N*mm*s/degree to about 0.2 N*mm*s/degree, preferable about 0.13 N*mm*sec/degrees to about 0.14 N*mm*sec/degrees.

Without intending to be bound by theory, a lower damping value could be representative of a connection portion which will oscillate more times before it comes to rest compared to a higher damping value, when released from the same position with an otherwise similar retention system (i.e., similar to the torsional retention member).

Without intending to be bound by theory, it is believed that damping can be impacted by a variety of aspects. As the connection portion rotates with respect to the grip portion about the first axis of rotation, contact between portions of the connection portion and grip portion can impact the damping. Contact points between other portions of the components that rotate (such as the connection portion or cartridge) to the grip portion of the handle can also impact damping. In one embodiment, one or more of these contact points can be designed to have increased or decreased friction to impact damping. Additionally, one or more of the contacting surfaces can be textured or lubricated to further control the damping. Various forms of texturing can be used, including but not limited to random stippling, sand papered affect, raised or depressed lines which can be parallel, cross hatched or in a grid.

Another way to control damping can be to control the amount of pressure between contacting portions of the connection portion and the grip portion. Further increasing or decreasing the area of contact between the moving parts can also impact damping.

In another embodiment, specific combinations of materials can be selected such that the friction between the structures can be increased or decreased. For example combinations of low and or higher coefficient of friction materials can be selected based on the desired amount of fiction.

There are several different ways to determine momentum of inertia of the components that rotate. Depending on the structures being considered, different types of momentum of inertia can be determined. In one embodiment, the momentum of inertia is determined as the “momentum of inertia of all moving parts”, which is defined herein as the momentum of inertia of all components that rotate about the rotational axis, relative to the grip portion of the handle. In an embodiment, the momentum of inertia of all moving parts includes the head unit, connection portion of the handle, and the connection member.

Another way to calculate momentum of inertia would be to calculate the momentum of inertia of the moving parts of just the handle (i.e., excluding the head unit). This form of momentum of inertia is hereafter referred to as “momentum of inertia of moving handle parts”.

For either of the types of momentum of inertias described above, the torsional retention member (i.e., the rod) can be included, or excluded. When including the torsional retention member, the momentum of inertia is referred to as the primary form of momentum of inertia (i.e., the “primary momentum of inertia of all moving parts”, or the “primary momentum of inertia of moving handle parts”). When excluding the torsional retention member, the momentum of inertia is referred to as the secondary form of momentum of inertia (i.e., the “secondary momentum of inertia of all moving parts”, or the “secondary momentum of inertia of moving handle parts”). Of course, the momentum of inertia(s) can be calculated with the head unit attached to the docking portion of the connection portion of the handle, or it can be calculated without the head unit attached.

In one embodiment, the primary momentum of inertia of all moving parts without the head unit is from about 0.05 kg*mm̂2 to about 1 kg*mm̂2, preferably from about 0.1 kg*mm̂2 to about 0.65 kg*mm̂2. In another embodiment, the primary momentum of inertia of all moving parts including the head unit is from about 0.5 kg*mm̂2 to 3 kg*mm̂2, preferably about 0.8 kg*mm̂2 to about 2 kg*mm̂2, most preferably about 1.2 kg*mm̂2.

In one embodiment, the secondary momentum of inertias can have similar ranges as described in the primary momentum of inertias, but less 0.001 kg*mm̂2 to about 0.01 kg*mm̂2, which could be attributed to the torsional retention member.

The shortest distance from the rotational axis of the connection portion to the center of mass of the components that rotate is also important in impacting the dynamic torsional resistance. In one embodiment the shortest distance from the axis of rotation of the connection portion to the center of mass of the components that rotate, referred to above and shown in FIG. 24 as Lp (900), is from about 0 mm to about 10 mm, preferably from about 1 mm to about 5 mm, more preferably about 2.4 mm. The location of the center of mass of the components that rotate or the pivot location of the head unit is not restricted to be between the rotational axis and the shaving surface, although this location can be preferred.

As defined herein, non-rotatably attached means that the end of the connection member (e.g., rod) attached to either the grip portion or the connection portion rotates with the portion to which it is attached. This means that the proximal end of the connection member is attached and rotates with the connection portion with respect to the grip portion, while the distal end of the connection member is attached to the grip portion and stays stationary with the grip portion, with respect to the rotating connection portion. Those of skill in the art will understand that the relative rotation of one end against the other causes the connection member to twist which can happen along the connection member body. Rotation of one end of the connection member versus the other will thereby allow the grip portion or the connection portion to rotate with respect to the other. Further, in one embodiment, both ends of the connection member can simultaneously rotate in opposite directions (clockwise and counterclockwise), or they can rotate in the same direction but one can rotate faster than the other, thereby still creating a twist in the connection member body.

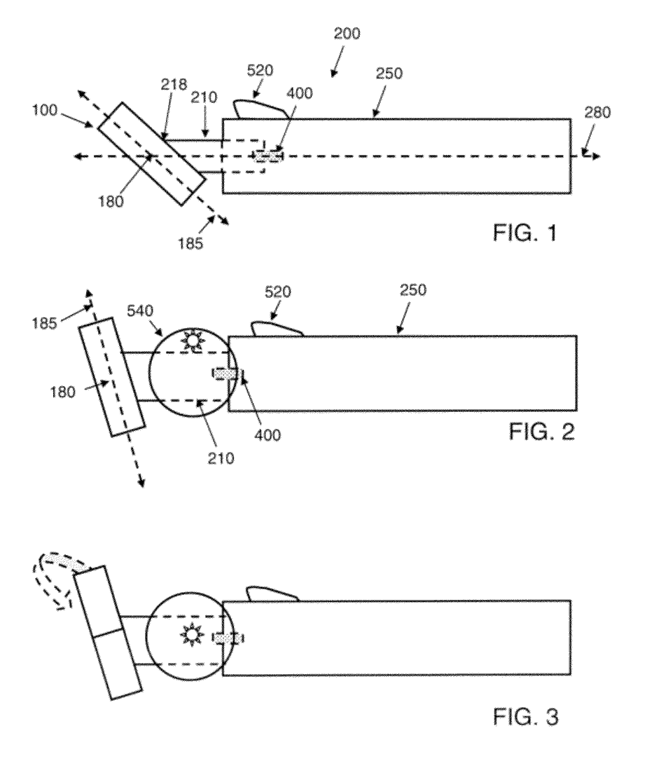

FIG. 1 is a side view of a hand held device in accordance with at least one embodiment of the present invention. FIG. 1 shows a handle (200), said handle comprising a grip portion (250) and a connection portion (210), said connection portion rotating with respect to said grip portion about a rotational axis (280), said connection portion (210) forming a docking portion (218) suitable for receiving an optional head unit (100), said docking portion (218) being positioned opposite distally away from said grip portion (250), wherein the grip portion and the connection portion are connected by a rod (400), said rod comprising a distal end (450) non-rotatably attached to the grip portion (250) and a proximal end (410) non-rotatably attached to the connection portion (210), wherein rotational axis (280) forms a central longitudinal axis of said rod (480). Also shown in FIG. 1 is an optional finger pad (520) positioned on the upper surface of the grip portion. The finger pad can be particularly useful to allow for enhanced user feel and control given the various types of rotation and pivoting possible with the present device. In one embodiment, the finger pad is positioned such that the pressure point of the finger pad is over at least a portion of the rod. The pressure point of the finger pad is the central area of applied pressure which a user's finger will create when they push on the finger pad. Preferably the pressure point will be in over the rotational axis (280). As long as the finger pad and or its pressure point sits directly above the rotational axis the user can still have a desirable amount of control during use. The rod need not be present under the finger pad as it can sit closer to the connection portion or closer to the interior of the grip portion.

The head unit (100) can include a wide scraping surface such as where the hair removal device is used with a depilatory or for skin exfoliation, or a blade unit, such as where the device is a safety razor. Where the hair removal head is a razor cartridge the cartridge may also include multiple blades. For example, U.S. Pat. No. 7,168,173 generally describes a Fusion® razor that is commercially available from The Gillette Company which includes a razor cartridge with multiple blades. Additionally, the razor cartridge may include a guard as well as a shaving aid. A variety of razor cartridges can be used in accordance with the present invention. Nonlimiting examples of suitable razor cartridges, with and without fins, guards, and/or shave aids, include those marketed by The Gillette Company under the Fusion®, Venus® product lines as well as those disclosed in U.S. Pat. Nos. 7,197,825, 6,449,849, 6,442,839, 6,301,785, 6,298,558; 6,161,288; and U.S. Patent Publ. No. 2008/060201.

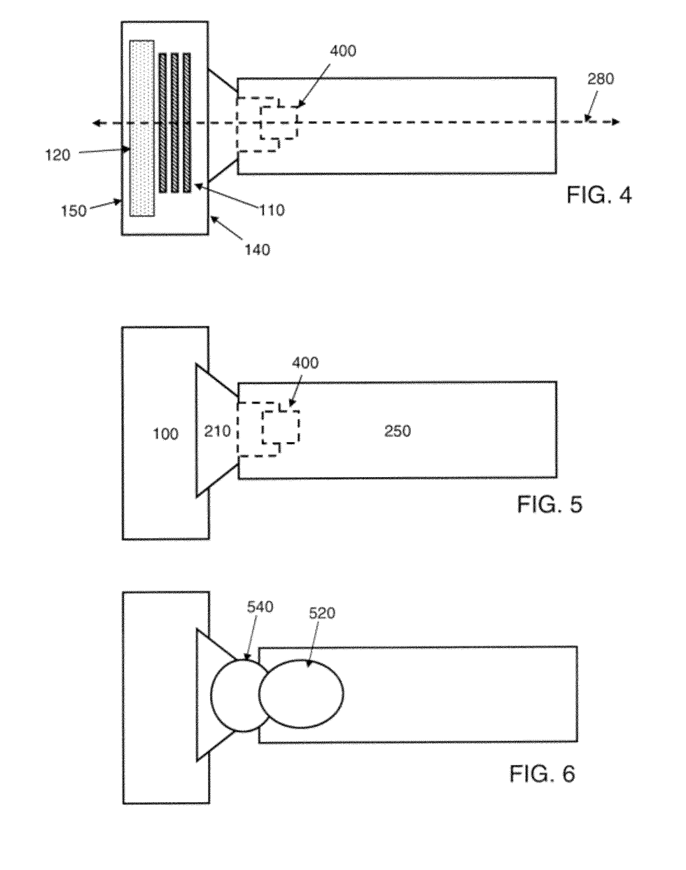

As shown in FIG. 4, where the head unit (100) is a said blade unit, the blade unit comprises a guard (140), a cap (150), at least one blade (110) positioned between the guard and the cap and a transverse centerline (185) extending through the guard and the cap in a direction substantially perpendicular to the at least one blade. “Substantially perpendicular” as defined herein means that when the device is in an at rest position (no external forces are applied to any parts of the device), where a first line intersects a second line, the intersecting line forms an angle of from about 85° to about 90°, or from about 88° to about 90°±0.1°. The transverse centerline divides the blade unit into substantially equal right half (184) and left half (182), as shown in FIG. 8.

The blade unit (100) pivots with respect to the connection portion (210) about a pivot axis (180) that extends substantially parallel to the at least one blade (110). The pivot axis (1800) is shown as a point in FIG. 1 as the axis extends normally out of the viewing plane. Where the head unit does not have a blade, it may still have an elongated scraping surface or edge or at least a lateral dimension which runs across the width of the head unit. “Substantially parallel” as defined herein means that when the device is in an at rest position (no external forces are applied to any parts of the device), the two lines sit on a plane but do not intersect or meet. Those of skill in the art will understand that the blade(s) and or head unit can have a slightly curved shape as such, substantially parallel means if a straight line were to be drawn through the at least one blade, that line is parallel to the pivot axis. The pivot axis can reside in front of the blades and below a plane tangential to the guard and cap. Other pivot positions are also possible. The blade unit may have a pivot range up to about 45° about pivot axis (180). Other pivot ranges both larger and smaller may be used if desired.

In one embodiment, the rotational axis (280) intersects at least one of said pivot axis and said transverse centerline (185) of the blade unit. Preferably, the rotational axis intersects at least the transverse centerline. Without intending to be bound by theory, the intersection of the rotational axis and the transverse centerline ensures that as rotations occur, the head unit rotates uniformly so that the portion rotating on the left is equal to the portion rotating on the right. Without intending to be bound by theory, it is also believed that this intersection aligns the head unit with the handle to provide a balanced hand held device. The intersection allows the right half (184) and left half (182) to rotate equally from one side to the other about handle (200). The connection portion (210) and accordingly the blade unit (100) may have a rotation range up to about 30° about rotational axis (280), e.g., about 15° in one direction and about 15° in the opposite direction. In one embodiment, the rotation range can be less than 30°, such as 20°. The rotation range can also be greater, for example up to 90°.

In one embodiment, the rotational axis (280) and the pivot axis (180) may intersect one another. Alternatively, the rotational axis may be spaced from the pivot axis, at their closest measured distance, by a distance of less about 10 mm, preferably less than about 5 mm. The closer the rotational axis (280) is to the pivot axis (180) the user has more control over the movement of the head unit (100) during use—this can be particularly useful in a shaving context as controlled pivoting and rotation of the blade unit can be important to certain users.

The terms “forward” and “aft”, as used herein, define relative position between features of the blade unit (i.e., razor cartridge). A feature “forward” of the at least one blade, for example, is positioned so that the surface to be treated with by the device encounters the feature before it encounters the at least one blade. For example, if the device is being stroked in its intended cutting direction, the guard is forward of the blade(s). A feature “aft” of the blade(s) is positioned so that the surface to be treated by the device encounters the feature after it encounters the blade(s), for example if the device is stroked in its intended cutting direction, the cap is disposed aft of the blade(s).

In one embodiment, the guard comprises at least one elongated flexible protrusions to engage a user's skin. In one embodiment, at least one flexible protrusion comprises flexible fins generally parallel to said one or more elongated edges. In another embodiment, said at least one flexible protrusion comprises flexible fins comprising at least one portion which is not generally parallel to said one or more elongated edges. Non-limiting examples of suitable guards include those used in current razor blades and include those disclosed in U.S. Pat. Nos. 7,607,230 and 7,024,776; (disclosing elastomeric/flexible fin bars); 2008/0034590 (disclosing curved guard fins); and 2009/0049695A1 (disclosing an elastomeric guard having guard forming at least one passage extending between an upper surface and a lower surface).

In one embodiment, the blade unit comprises at least one skin engaging member such as a conventional shave aid or lubrication strip. The skin engaging member can be positioned forward of the blade(s) and/or aft of the blade(s). Non-limiting examples of known skin conditioning compositions suitable for use herein include shave aids and lubrication strips as described in: U.S. Pat. Nos. 7,581,318, 7,069,658, 6,944,952, 6,594,904, 6,302,785, 6,182,365, D424,745, 6,185,822, 6,298,558 and 5,113,585, and U.S. Patent Application Publication No. 2009/0223057.

In one embodiment, the skin engaging member comprises a skin conditioning composition comprising at least one emollient and a water insoluble structuring polymer forming an erodible, solid moisturizing composition. Examples of such compositions have been described as an erodible, solid moisturizing composition described in copending U.S. Patent Application Ser. Nos. 61/305,682 titled “HAIR REMOVAL DEVICE COMPRISING ERODIBLE MOISTURIZER” and 61/305,687 titled “HAIR REMOVAL DEVICE COMPRISING AN ERODIBLE MOISTURIZER”, both to Stephens et al., filed Feb. 18, 2010. In one embodiment, the skin engaging member can form a continuous or partial ring around the blade(s) as described in U.S. Ser. No. 12/906,027 titled “SKIN ENGAGING MEMBER FORMING A RING” to Stephens et al., filed Oct. 15, 2010. Without intending to be bound by theory, this can be particularly useful to ensure that any skin conditioning compositions such as moisturizers and/or lubricants can be deposited on the surface to be treated even throughout the various types of motion and rotation possible with the present device.

FIG. 2 is a side view of another hand held device in accordance with at least one embodiment of the present invention. This embodiment has a similar head unit to that shown in FIG. 1 for illustrative purposes of the pivot action of the head unit about pivot axis (180). In this figure, the head unit pivoting such that the portion with the cap pivots towards the handle while the portion with the guard pivots away from the handle. Also shown in this figure is a finger pad (520) positioned on the upper surface of the grip unit of the handle. In this embodiment, the connection portion (210) does not have a region sitting inside the grip portion (250) (as shown in FIG. 1). In another embodiment, a portion of the grip portion can protrude into the connection portion and the rod can be positioned beyond the farthest reaching portion of the grip portion. In FIG. 2, the connection portion and the grip portion form a surface interface. The rod (400) extends into each portion and allows the portions to rotate with respect to the other.

Also shown in FIG. 2 is a cap member (540) which can be used to cover a portion of the interface between the connection portion (210) and the grip portion (250). In one embodiment, the cap member has a rounded or oval shape. Preferably, the cap member rotates along with the connection portion (210) about the rotational axis (280). In one embodiment, the cap member has a central axis which can overlap with the rotational axis such that during rotation of the connection portion, the cap member does not move but merely rotates. FIG. 3 is a side view of the hand held device of FIG. 2, with the head unit partially rotated. The relative movement of the surface indicia (shown as a sun) and the cap member in a downward rotation from the viewing perspective in these exemplary figures is provided to more clearly show the rotational movement. An arrow showing rotation has also been provided. As shown here, the connection portion (210) forms a docking portion (218) for receiving the head unit. In an alternative embodiment, the cap is configured to not move or rotate with the connection portion.

FIG. 4 is a bottom view of a hand held device in accordance with at least one embodiment of the present invention. In this example, the device is a safety razor with a blade unit comprising three blades (110) and a shaving aid (120) positioned aft of said blades. Cap (150) is further aft of the shaving aid and the guard (140) is forward of the blades. FIG. 5 is a top view of the device shown in FIG. 4.

FIG. 6 is a top view of another hand held device in accordance with at least one embodiment of the present invention. FIG. 6 shows a cap member (540) and a finger pad (520).

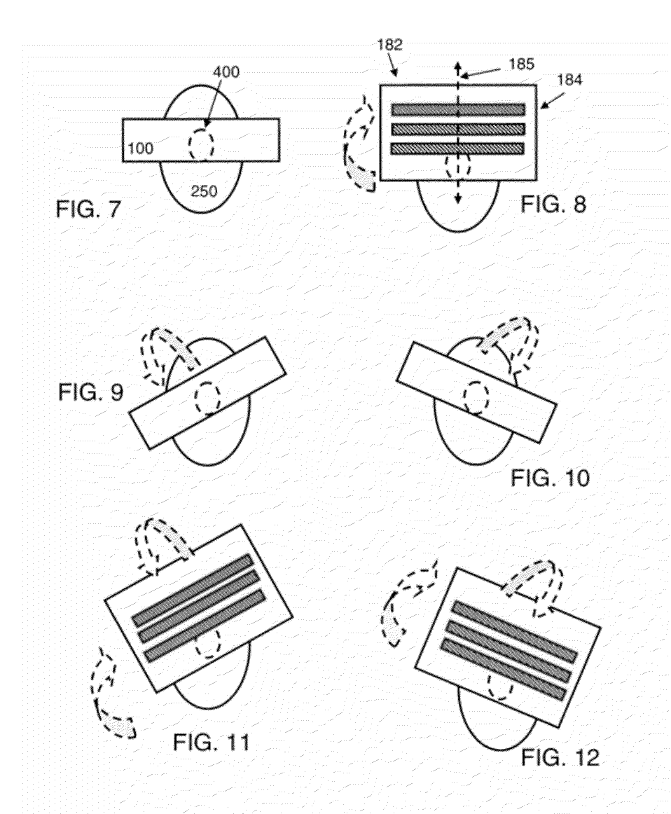

FIGS. 7-12 show a frontal view of a safety razor in accordance with the present invention. FIG. 7 is in an at rest position where the blade unit (100) is not pivoted or rotated. The central longitudinal axis of the rod (not shown) overlaps with the rotational axis (not shown). FIG. 8 shows the same razor but pivoted so the cap of the blade unit approaches the handle (250). Also shown in FIG. 8 is the transverse centerline which separates the blade unit into substantially equal left half (182) and right half (184).I FIGS. 9 and 10 show the blade unit not being pivoted but the connection portion and blade unit being rotated counterclockwise, and clockwise, respectively. FIG. 11 shows counterclockwise rotation with pivoting. FIG. 12 shows clockwise rotation with pivoting.

In one embodiment, the head unit has a maximum rotation of from about 5° to about 90°, preferably from about 10° to about 30°, preferably about 15° from an at rest position, ±1°. Without intending to be bound by theory, it is believed that a maximum rotation of about 15° is particularly desirable for a razor execution.

Rod

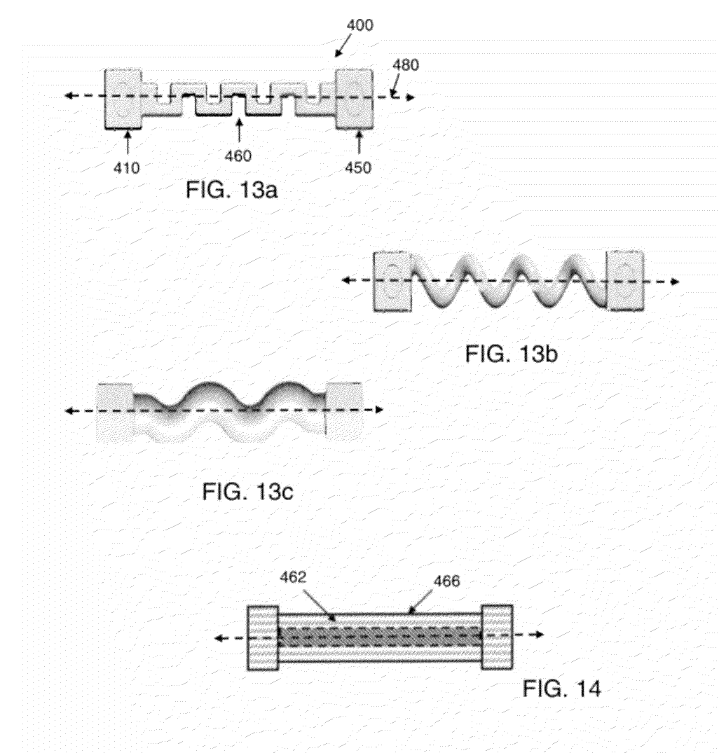

FIGS. 13-14 show different versions of suitable rods for use in accordance with the present invention. Between distal end (450) and proximal end (410) is rod body (460). Various shapes for the ends and rod body can be used. The rods of FIGS. 13a and 13b have oscillating wave patterns with a squared or rounded cross sectional area, respectively. The rod of FIG. 13b is like a spring. The body (460) of the rod of FIG. 14 is cylindrical.

As explained above and shown in the figures, at least a portion of the rotational axis of the hand held device forms a central longitudinal axis of said rod. As the connection portion of the device rotates with respect to the grip portion, the rotation occurs about the rotational axis and the central longitudinal axis of the rod. In effect, the rod becomes a spine, about which the connection portion and the optional head unit, can rotate in a clockwise or counterclockwise orientation with respect to the grip portion. The flexible and twistable nature of the rod allows for torsional rotation but creates a biasing force to return the device back to an at rest orientation. It has importantly been found that a rotation range of from about 0° to about 45°, preferably from about 0° to about 30°, most preferably from about 0° to about 15°, as measured from the at rest position, is suitable for various uses, such as when the hand held device is a wet or dry power or manual shaving razor and the head is either disposable or replaceable. In one embodiment, rotating said connection portion from a zero position by 15° generates from about 20 Nmm to about 40 Nmm of torque±0.1 Nmm, preferably from about 28 Nmm to about 35 Nmm±0.1 Nmm, and even more preferably about 21 Nmm to about 24 Nmm. Without intending to be bound by theory, it is believed that this provides a desired range of torsional resistance during use such that the user can feel the return force biasing the head and connection portion back to an at rest 0° orientation. Those of skill in the art will understand that greater or less torsional resistance can be desired based on user preference.

In these exemplary figures, the ends are squared so they can be placed into receiving regions of the connection portion and grip portion so they become non-rotatably attached thereto. The body portion (460) twists as the connection portion and grip portion rotate with respect to one another. In one embodiment, the ends have the same shape, such as a square or rectangular shape. In another embodiment the ends have different shapes, as long as the end can be non-rotatably attached to one of said connection portion or said grip portion. In another embodiment, one or both of the ends have the same cross sectional shape as a portion of the rod body. For example, the entire rod has the same cross sectional shape, such as a cylinder or an elongated rectangle.

In one embodiment, one or both of the ends can be non-rotatably attached to the portion of the handle by a fitting into a receiving space within the respective portion. In another embodiment, the receiving space can further form a protrusion which fits into a void space within the end, such as a pin which can fit into void in the end, or vice versa where the protrusion is formed in the end and fits into a void in the receiving region of the portion of the handle.

In one embodiment, the rod is permanently attached to at least one of said grip portion and said connection portion. Where the rod is permanently attached to one of said grip portion and said connection portion, it can be integrally formed with said respective grip portion or said connection portion. “Integrally formed”, as used herein means that two structures are formed together as part of the same single step or multiple step making process, such as where the structures are molded together or in a multi-shot mold, or where the two structures are separately formed then permanently affixed to each other before being assembled with any other portions of the device.

In one embodiment, the rod and respective portion of the handle to which it is integrally formed is affixed via any known method for attaching two structures, including but not limited to via an adhesive, a heat seal, or by ultrasonic welding. In one embodiment, the rod and respective portion of the handle to which it is non-rotatably attached is permanently affixed via one of the previously mentioned methods but the structures need not be integrally formed (meaning that the attachment can occur after other structures of the device are already assembled). The permanent attachment can be by integrally forming as described above.

In one embodiment, both ends of the rod can be permanently attached to each of their respective portions of the handle. Preferably, only one of the ends would be integrally formed with its respective handle portion. In this example, it may be useful to have the rod integrally formed with the connection portion but the rod can also be integrally formed with the grip portion as well.

In one embodiment, only one end of the rod is permanently attached to its respective portion of the handle. The end of the rod which is not permanently attached can be removably attached to the other of said grip portion and said connection portion. “Removably attached” means that the attachment can be by a structural attachment such as a fitment where the end anchors or hooks into or onto the receiving region of the portion of the handle, or the protrusion/void or male/female mating system described above. In one embodiment, the distal end is permanently attached to the grip portion and the proximal end is removably attached to the connection portion. The reverse could also be possible where the distal end is removably attached and the proximal end is permanently attached. In another embodiment, the rod is removably attached to both of said grip portion and said connection portion.

In one embodiment, the rod is at least partially formed from a material comprising at least one of a polymeric material, steel (e.g., stainless steel), or a combination thereof. Any material suitable for use in a hand held device which is flexible and can provide torsional stress which can occur during use without breaking can be used. In one embodiment, the polymeric material is selected from the group consisting of: an acetal, a polyacetal, a polyoxymethylene, polyphenylene sulfide, a polyamide, a polybutylene terephthalate, a thermoplastic elastomer, a thermoset elastomer, a polyurethane, a silicone, a nitrile rubber, a styrenic block copolymer, polybutadiene, polyisoprene, and mixtures or copolymers thereof. In one embodiment of the present invention, the polymeric material comprises polyoxymethylene, commercially available as Delrin DE9422 from DuPont®.

In one embodiment, the rod comprises a first layer and a second layer. The layers can be in the form of a central core and a sheath layered externally to the central core. FIG. 14 shows such an example where a first layer (462) is laminated with a second layer (466). In another embodiment, layers can just be laminated onto one another as two sheets forming the rod. In one embodiment, the first layer and the second layer are not made of the same material, for example the first layer can be steel and the second layer can be the polymeric material. In another embodiment, the rod is formed of just a single material.

In one embodiment, the material forming a portion of the rod have a Young's modulus of from about 0.01 GPa to about 200 GPa, preferably from about 0.01 GPa to about 10 GPa by tensile testing for plastics, according to ASTM D638. Without intending to be bound by theory, it is believed that using a material with such a Young's modulus has desirable elastic properties for use with the device of the present invention. Those of skill in the art will understand that Young's modulus is an intrinsic property. Depending on the specific type of material(s) used the shape and amount of the material can be modified to provide the desired rotational resistance desired.

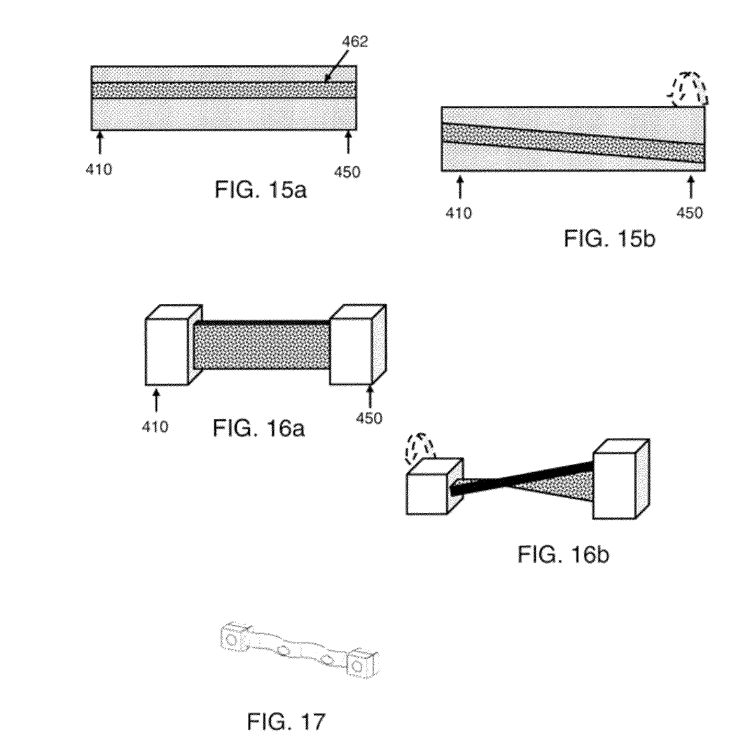

FIGS. 15a and b show exterior views of a cylindrical rod or at least a rod body having a surface marking line (462). The rod in 15a is at rest while the rod of 15b is partially rotated. In 15b, as the distal end (450) is at least partially rotated, while the proximal end is held still, surface marking line (462) shows the twisting deformation of the rod. One of skill in the art will understand that although the proximal end and distal end are shown having the same shape as the rest of the rod body, the ends can have different shapes.

FIGS. 16a and 16b show another rod in accordance with at least one embodiment of the present invention, wherein the proximal end (410) is rotated by 90° such that the rod body twists while distal end (450) stays stationary and does not rotate. As shown in this embodiment, the rod can be relatively thin in terms of thickness or width but be long so the rod has a generally thin rectangular shape. In one embodiment, the rod body can be layered along the width of the body such that the layers form a laminate like a layered stick of gum from Trident®. In another embodiment, the rod body can be layered along the height of the rod body like a multi-layered cake.

FIG. 17 is another rod in accordance with at least one embodiment of the present invention. The rod body of this embodiment can have one or more apertures formed throughout the length of the rod body. Furthermore, the rod body itself can form oscillating waves in and out of the viewing plane when viewed from a side view. As such, in one embodiment, the rod body can be corrugated and/or form one or more apertures.

Finger Pad

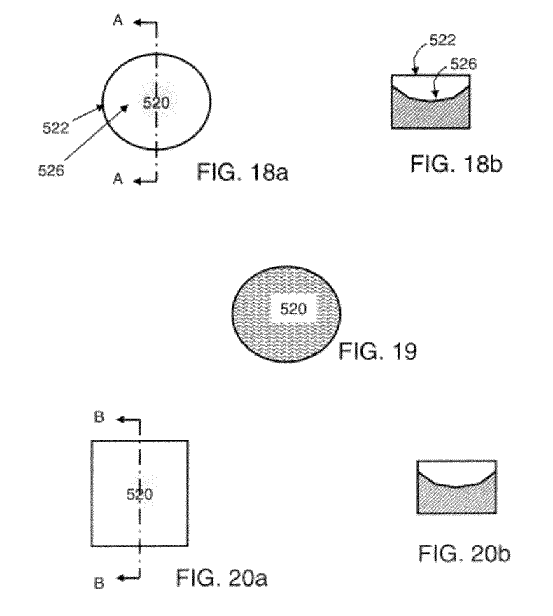

FIG. 18a is a top view of a finger pad (520) in accordance with at least one embodiment of the present invention. The finger pad (520) has an oval shape and an interior region (526) with raised side walls (522). FIG. 18b is a cross sectional view of the finger pad of FIG. 18a view along view line A-A. The interior region (526) is recessed so it sits lower than the raised side walls (522) such that a user placing a finger into the finger pad can press down into the middle of the finger pad but also apply lateral pressure against the front portion or side portions of the raised side walls (522). This can be particularly useful since the device of the present invention allows for pivoting and rotation of the head. Without intending to be bound by theory, it is believed that the finger pad allows for added control as the head unit contours over the surface it is being engaged over. For example, where the device is a safety razor, the finger pad allows the user to maintain control while contouring the blade unit by pivoting and/or rotating.

FIG. 19 is another top view of a finger pad. In one embodiment, the finger pad can be textured to increase traction to the finger. Any suitable texture can be used such as dimpling or scored or raised in a linear or cross hatch orientation. In another embodiment, selection of various and different materials can also enhance tactile feedback for the finger pad.

FIG. 20a is a top view of another finger pad (520) in accordance with at least one embodiment of the present invention. This finger pad has a square or rectangular shape. Other shapes can also be used, such as a triangular shape. FIG. 20b is a side view of the finger pad of FIG. 20a view along view line B-B. This embodiment can also have a recessed interior region with raised side walls.

The finger pad can be placed such that it sits atop a portion of the rod when the device is viewed from a top view similar to FIG. 6. The finger pad need not be placed over the rod but the finger pad should have a central axis which is parallel with the rotational axis and is positioned above said rotational axis when the device viewed from a top view as shown in FIG. 6.

In one embodiment, the device comprises a window formed in one or both of the connection portion and the grip portion. In one embodiment, the finger pad can be clear or transparent such that it forms the window. In another embodiment, the device comprises the finger pad and a separate window. In one embodiment, a portion of said rod, such as the rod body, or all of said rod is exposed via a window formed in said grip portion, said connection member, or a combination thereof.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm” All measurements are performed at 25° C., unless otherwise specified.

All documents cited in the DETAILED DESCRIPTION OF THE INVENTION are, in the relevant part, incorporated herein by reference; the citation of any document is not to be construed as an admission that it is prior art with respect to the present invention. To the extent that any meaning or definition of a term or in this written document conflicts with any meaning or definition in a document incorporated by reference, the meaning or definition assigned to the term in this written document shall govern. Except as otherwise noted, the articles “a,” “an,” and “the” mean “one or more.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A handle for use on a hand held device, said handle comprising:
a. a grip portion and a connection portion, said connection portion rotating with respect to said grip portion about a rotational axis, said connection portion comprising a docking portion suitable for receiving an optional blade unit, said docking portion being positioned opposite distally away from said grip portion,
b. wherein the grip portion and the connection portion are rotatably connected by a connection member, and
i. wherein said handle comprises a static stiffness in a range of about 1.25 N*mm/degree to about 1.45 N*mm/deg, as determined by the Static Stiffness Method defined herein.

2. The handle of claim 1, wherein said blade unit comprises at least one blade, said head unit pivots with respect to the connection portion about a pivot axis substantially parallel to said at least one blade.

3. The handle of claim 2, wherein the handle has a damping of from about 0.13 N*mm*seconds/degree to about 0.16 N*mm*sec/degree, as determined by the Pendulum Test Method defined herein, and a primary momentum of inertia of moving handle parts of from about 0.05 kg*mm̂2 to about 1 kg*mm̂2.

4. The handle of claim 2, further comprising a primary momentum of inertia of all moving parts in a range of 0.5 kg*mm̂2 to 3 kg*mm̂2, preferably about 1 kg*mm̂2 to about 2 kg*mm̂2, most preferably about 1.2 kg*mm̂2.

5. The handle of claim 2, wherein a shortest distance from rotational axis to the pivot axis of the head unit is in a range of about 0 mm to about 10 mm.

6. The handle of claim 1, wherein the connection portion and the connection member are integrally formed.

7. The handle of claim 1, wherein a material forming at least a portion of the rod comprises at least one of a polymeric material, steel, or a combination thereof, and wherein said polymeric material is selected from the group consisting of: an acetal, a polyacetal, a polyoxymethylene, polyphenylene sulfide, a polyamide, a polybutylene terephthalate, a thermoplastic elastomer, a thermoset elastomer, a polyurethane, a silicone, a nitrile rubber, a styrenic block copolymer, polybutadiene, polyisoprene, and mixtures or copolymers thereof.

8. The handle of claim 1, wherein rotating said connection portion from a zero position by 12° generates about 21 Nmm to about 24 Nmm of torque.

9. A handle for a safety razor comprising:
a. a grip portion and a connection portion, said connection portion rotating with respect to said grip portion about a rotational axis, said connection portion comprising a docking portion suitable for receiving an optional blade unit, said docking portion being positioned opposite distally away from said grip portion,
b. wherein the grip portion and the connection portion are connected by a rod, said rod comprising a distal end non-rotatably attached to the grip portion and a proximal end non-rotatably attached to the connection portion, wherein said rotational axis forms a central longitudinal axis of said rod,
c. wherein said handle comprises;
i. a static stiffness in a range of about 0.3 N*mm/degree to about 2.5 N*mm/deg, as determined by the Static Stiffness Method defined herein, and
ii. a damping in a range of about 0.03 N*mm*sec/degrees to about 0.6 N*mm*sec/degrees, as determined by the Pendulum Test Method, defined herein.

10. The handle of claim 9, wherein said blade unit comprises at least one blade, said head unit pivots with respect to the connection portion about a pivot axis substantially parallel to said at least one blade.

11. The handle of claim 9, wherein the handle has a damping of from about 0.13 N*mm*seconds/degree to about 0.16 N*mm*sec/degree, as determined by the Pendulum Test Method defined herein, and a primary momentum of inertia of moving handle parts of from about 0.05 kg*mm̂2 to about 1 kg*mm̂2.

12. The handle of claim 9, further comprising a primary momentum of inertia of all moving parts in a range of 0.5 kg*mm̂2 to 3 kg*mm̂2, preferably about 1 kg*mm̂2 to about 2 kg*mm̂2, most preferably about 1.2 kg*mm̂2.

13. The handle of claim 10, wherein a shortest distance from rotational axis to the pivot axis of the head unit is in a range of about 0 mm to about 10 mm.

14. The handle of claim 9, wherein the rod is permanently attached to at least one of said grip portion and said connection portion.

15. The handle of claim 9, wherein the rod is removably attached to at least one of said grip portion and said connection portion.

16. The handle of claim 9, wherein a material forming at least a portion of the rod comprises at least one of a polymeric material, steel, or a combination thereof, and wherein said polymeric material is selected from the group consisting of: an acetal, a polyacetal, a polyoxymethylene, polyphenylene sulfide, a polyamide, a polybutylene terephthalate, a thermoplastic elastomer, a thermoset elastomer, a polyurethane, a silicone, a nitrile rubber, a styrenic block copolymer, polybutadiene, polyisoprene, and mixtures or copolymers thereof.

17. The handle of claim 9, wherein rotating said connection portion from a zero position by 12° generates about 21 Nmm to about 24 Nmm of torque.

18. The handle of claim 9, wherein the connection portion and the rod are integrally formed.
